(19) United States
(12) Patent Application Publication
(10) Pub. No.: US 2013/0073343 A1
(43) Pub. Date: Mar. 21, 2013

(54) Task Completion Tracking and Management System

(71) Applicants: Richard A. Richardson, Stratford, CT (US); Pedro DeAbreu, Fairfield, CT (US)

(72) Inventors: Richard A. Richardson, Stratford, CT (US); Pedro DeAbreu, Fairfield, CT (US)

(21) Appl. No.: 13/624,005

(22) Filed: Sep. 21, 2012

Related U.S. Application Data
(60) Provisional application No. 61/537,374, filed on Sep. 21, 2011.

(51) Int. Cl. G06Q 10/06

(52) U.S. Cl. 705/7.38

(57) ABSTRACT

A task fulfillment system is provided for facilitating the management and completion of activities by both single and team users. The system uses a social network platform to bring local community members together for the purpose of participating in activities and achieving life goals. Both personal and business users may submit tasks to the system, which are then available for others to view. Interested users select tasks to participate in and the system tracts their progress towards task completion. Users can participate individually or group together in teams to undertake larger projects. Earned points may be used for special promotions, discounts with website advertisers, or discounts on future task activities. The system provides a ranking method based on points earned for task completion. It thus inspires competition amongst community members and instigates participating in a variety of activities.

### CROSS REFERENCE TO RELATED APPLICATION

This application claims the benefit of U.S. Provisional Application No. 61/527,274 filed on Sep. 21, 2011, entitled “Life's Hunt”, for purposes of providing continuity of disclosure, the aforementioned application is incorporated herein by reference.

### BACKGROUND OF THE INVENTION

1. Field of the Invention

The present invention relates to a system for managing task setting and completion. More specifically, it provides a system for users to interact through a social network platform to complete goals and activities. Users may participate individually or in teams to accomplish tasks of their choosing. Points are assigned based on several factors, and system users are ranked based on points earned. Thus the system provides a means for setting goals, tracking goal completion and ranking system participants based on goal completion statistics.

The Internet is a network of networks and gateways that use the TCP/IP suite of protocols. A client is a computer accessed by a user or viewer that issues commands to another computer called a server. The server performs a task associated with the client's command. The World Wide Web is the Internet's application, which displays information on the Internet in a user-friendly graphical user interface format called a Web page. A Web server typically supports one or more clients. The Web allows users (at a client computer) who seek information on the Internet to switch from server to server and database to database by viewing objects (images or text) and clicking (with a pointing device or keystroke) on corresponding highlighted words or phrases of interest (hyperlinks).

The Web can be considered as the internet with all of the resources addressed or identified as Universal Resource Locators (URLs) and which displays the information corresponding to URLs and provides a point-and-click interface to other URLs. A URL can be thought of as a Web document version of an e-mail address. Part of a URL is termed the Internet Protocol (IP) address.

An Internet browser or Web browser is a graphical interface tool that runs Internet protocols and displays results on the user's screen. The browser can act as an Internet tour guide, complete with pictorial desktops, directories and search tools used when a user “surfs the net.” With the ever-increasing number of people turning to the Internet for news, entertainment, and social interaction, the Internet provides tremendous opportunity for people to make new friends, talk to community members, and take up new hobbies.

Traditional online communities and social networking websites provide a variety of functions designed to keep users logged in to the website, so they can interact with other users online. These functions, though useful, often have the effect of making people less social in outside the digital world, because people exercise their need for interaction through the online community. Social networking websites are littered with comments by users about the things they would like to be doing rather than sitting around in front of the computer. Yet, users continue to spend time online engaged in digital social interaction as facilitated by web communities and social networking media. Sometimes users will take advantage of the website to organize group activities or invite others to join them at an event, but the user must provide the event as the website will not present suggestions to bored users. Such suggestions might seem counter-productive to website administrators because if successful the suggestions would pull people away from the website and its advertisers.

Despite the potentially detrimental effects on social interaction that are posed by some social networking sites, the social networking platform is highly effective at bringing users together online. If social networking could be used to bring people together online and then propose ways for users to physically interact, the social networking website could offer substantial improvement to the social health of its users. An online community is needed that encourages users to try new activities, pick up hobbies, meet new people, and attend events. The present invention provides such a website through a task fulfillment system that uses the input of personal and business users to suggest activities, hobbies, and event to individuals and teams of users. Points are earned for task completion and users are ranked according to their earned points. Thus the purpose of the present system is to bring people together online so that they can participate in activities away from their computer.

2. Description of the Prior Art

The present invention relates to a multi-user task fulfillment and ranking system. A social networking platform is used to provide users with a means for interacting with and forming links between members of a community. These interactions and links can be used to form teams that can complete tasks and accrue rewards jointly or as individuals. Persons, who wish to participate in active community events, make new friends, try new hobbies, and evaluate their personal strengths and weakness will appreciate the present system. The prior art contains several goal-fulfillment systems but none of these are as expansive and interactive as the present invention. Nor do the prior art systems and methods disclose a ranking system that provides users with a means for evaluating their task performance and competing against other users for ranking rewards.

A system and method for tracking completion of healthcare goals within a social networking platform is described by Metzler, U.S. Patent Application Publication no. 2011/0046981. The system provides individual users with a means for tracking their progress during a recovery process. A health care provider can set up an account for a user and determine the steps needed for a user to achieve a health recovery goal. As users complete various stages of the recovery process they provide input into the system, such as “went to orthopedist on Jun. 26, 2011.” Input may also be provided in the form of gps location information obtained via user cell-phone, which can help ascertain that a user is “currently at the orthopedist.” This allows healthcare providers to keep track of a user's progress and provide feedback throughout the patient recovery process. Updates can also be sent to third parties to let friends and family know how the patient is progressing. This system does not provide an open social network platform where users can link to each other and view each other's task completions. For privacy reasons it would be impractical to provide access to a patient's healthcare information to other individuals who are not permitted to have access by a patient's informed consent. The system also does not provide a ranking system, award system, or team formation module. Once again, privacy concerns would make such elements difficult to implement in a healthcare provider system. The present invention includes these elements and is thus not limited to a single user goal completion system.

Some systems do offer multi-user engagement of a specific task. An example is commercial systems that are designed to serve as an intermediary between those who need tasks completed and those who are willing to perform the tasks. Such a system is disclosed by Cohen et al, U.S. Pat. No. 7,881,957, Cohen discloses a system and method where task performers can sign up for a subscription to receive notice about submitted task performance requests based on the type of task. Task performers can also search for current task performance requests by category, keyword and other search criteria. A marketplace structure is provided through which task performance requests can assign compensation to be given in exchange for completion of the task. This system is designed to assist performance requestors with obtaining useful human feedback and a form of artificial intelligence that can be used in the performance requestor's data gathering and computations. The system does not provide a ranking system, reward system, a team formation module, or means for setting goals that require completion of a number in of tasks in order to complete the goal. The present invention includes these elements within a social networking platform.

Another multi-user task system describes a method for selecting members of a team for task performance. John et al, U.S. Patent Application Publication No. 2008/0120261 discloses a method for selecting members of a task performance team based on evaluation of the strength of connection between proposed team members. A social network model is used to evaluate and assign significance of communication between members of a business organization. Factors for evaluation include but are not limited to, number of interactions and success of previous projects undertaken between two persons. Additionally the backgrounds and talents of prospective team members are evaluated prior to team generation. Once strength of cohesiveness is estimated between prospect team members, the method builds a team to perform a particular task. This method is highly advantageous to large business corporations who need easy means of assigning project duties to employees, but it is not advantageous to an open social network of community members who desire to choose their own interaction criteria. The John method does not permit end-users to assemble their own teams of varying size base on the user's particular preferences. Rather, the John system allows the task creator to specify the number of participants, skill sets needed, and other necessary criteria. The present invention provides users with a means for creating their own teams to create a task, or opting to undertake a task individually. Users may choose friends, solicit community members to join their team, or open the team up to interested persons who want to join. The present invention thus provides father greater flexibility in joint venture creation. It encourages meeting new people and interacting with previously unknown members of the community who may possess desired skill sets.

The prior art fails to disclose a task fulfillment system that provides a ranking and reward system for users to evaluate task performance. The present invention encourages friendly competition between users by assigning rankings to users based on task completion criteria. It substantially diverges in design elements from the prior art and consequently it is clear that there is a need in the art for an improvement to existing task fulfillment systems. In this regard the instant invention substantially fulfills these needs.

### SUMMARY OF THE INVENTION

In view of the foregoing disadvantages inherent in the known types of task fulfillment systems now present in the prior art, the present invention provides a new ranking system and task completion groups, wherein the same can be utilized for providing convenience for the user when participating in activities and accomplishing goals with community members.

It is therefore an object of the present invention to provide a new and improved task fulfillment system that has all of the advantages of the prior art and none of the disadvantages.

Another object of the present invention to provide a task fulfillment system is an online community that tracks a user's personal progress towards specified goals and then ranks the user against other members of the community.

Another object of the present invention to provide an online social network that connects members of a local community through participation in local activities and events.

Another object of the present invention is to provide a task fulfillment system that tracks completion of activities in furtherance of a user's designated goals.

Another object of the present invention is to provide a task completion system in which new tasks are submitted by system members thereby creating an expansive and ever-growing database of tasks for users to undertake.

Yet another object of the present invention is to provide a user with the ability to track his or her progress on numerous tasks.

Still another object of the present invention is to provide a ranking database that assigns a score to tasks then grades users on their completion. The ranking system compares users and ranks them according to criteria such as: number of tasks completed, score on a particular task, and tasks completed within a period of time.

A further object of the present invention is to provide a task database that receives input from local businesses to create new “tasks” for users to perform.

A still further object of the present invention is to provide a means for community member to form online groups that can be used to complete tasks.

A yet further object of the present invention is to provide a means for bringing community members closer together and initiating new friendships.

Another object of the present invention is to provide a system that encourages users to engage in physical activities and real world experiences, thereby encouraging mental, emotional, and physical health.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general system diagram of an exemplary embodiment of the task fulfillment system.

FIG. 2 shows a system diagram of a business user submitting an activity to the system and the generation of a “task” based on the user's submission.

FIG. 3A shows a diagram of the primary embodiment of the interaction between the member and task databases via several modules.

FIG. 3B shows an alternative embodiment of the interaction between the member database and task database, incorporating an advertising module.

FIG. 4 shows a flowchart depicting the progression of a user's search for tasks within the system, via the search module.

FIG. 5 shows a flowchart depicting how the system handles tracking of tasks, via the task module.

FIG. 6 shows a flow chart illustrating an exemplary embodiment of how points are earned by users of the system.

FIG. 7 shows flowchart of the advertising module's delivery of advertising to system users via interactions with other system modules.

FIG. 8 shows an exemplary implementation of the communications module and depicts several means for user-to-user interaction.

FIG. 9 shows a view of a member user interface task-tracking screen.

FIG. 10 shows a view of a personal user interface system rankings screen.

### DETAILED DESCRIPTION OF THE INVENTION

Reference is made herein to the attached drawings. Like reference numerals are used throughout the drawings to depict like or similar elements of the task fulfillment system. For the purposes of presenting a brief and clear description of the present invention, the preferred embodiment will be discussed as used for tracking task completion and interacting with community members. The figures are intended for representative purposes only and should not be considered to be limiting in any respect.

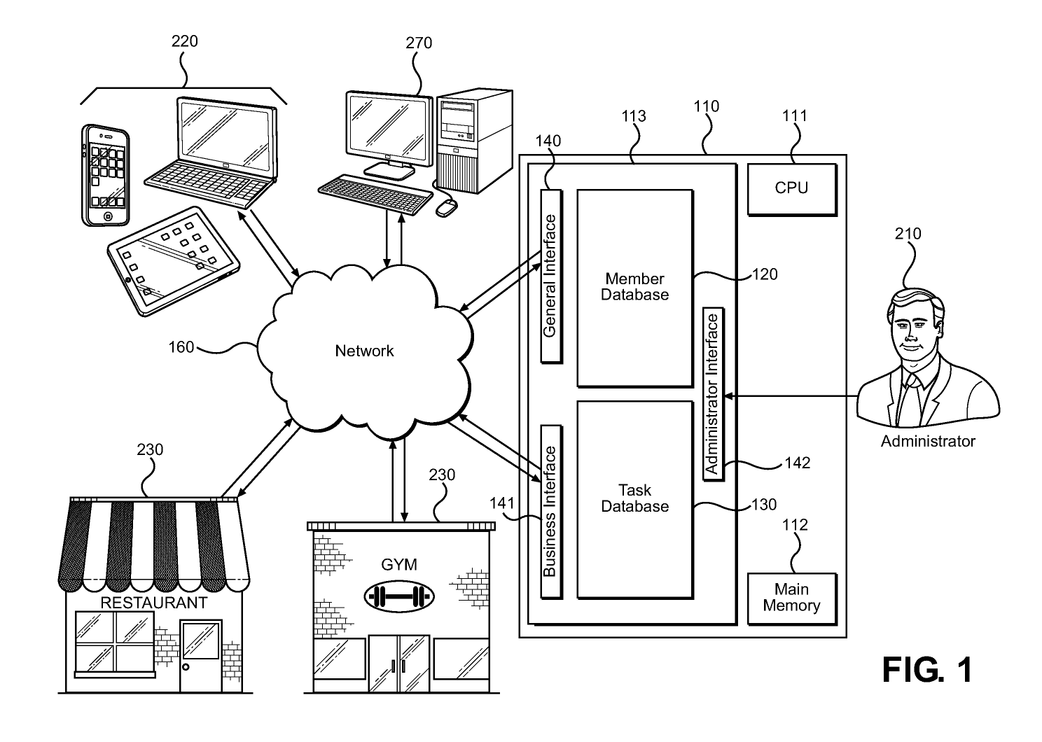

Referring now to FIG. 1, there is shown a general architecture diagram of the task fulfillment system. At least one server 110 is provided and comprises a central processing unit (CPU) 111, a storage medium 112, and a main memory 113. The storage means stores a data collection, exemplified herein as a member database 120, a task database 130, and various files necessary for a website. These databases will contain information about system members and submitted tasks, for access by system administrators 210, personal users 220 that may be individuals or teams 221 of people, and business users 230. The system website offers a different interface for each type of user. A general user interface 140 provides access to personal users; a business interface 141 is provided for business users; and the administrator interface 142 enables administration of the system by administrative users. Main memory performs calculations associated with system use and the computing functions necessary to facilitate management and tracking of user goals. Personal users and Business users will interact with the system through an external network 160 such as the internet, while Administrator users may interact with the system directly through a local area network (LAN) or through the internet. A variety of devices may be used to interact with the system such as smart phones, PDAs, laptops, tablet computers, and the like. Thus the system is convenient to use and may be accessed in the comfort of a user's home or business, or while travelling. Mobile availability allows goal completion to be checked at any time.

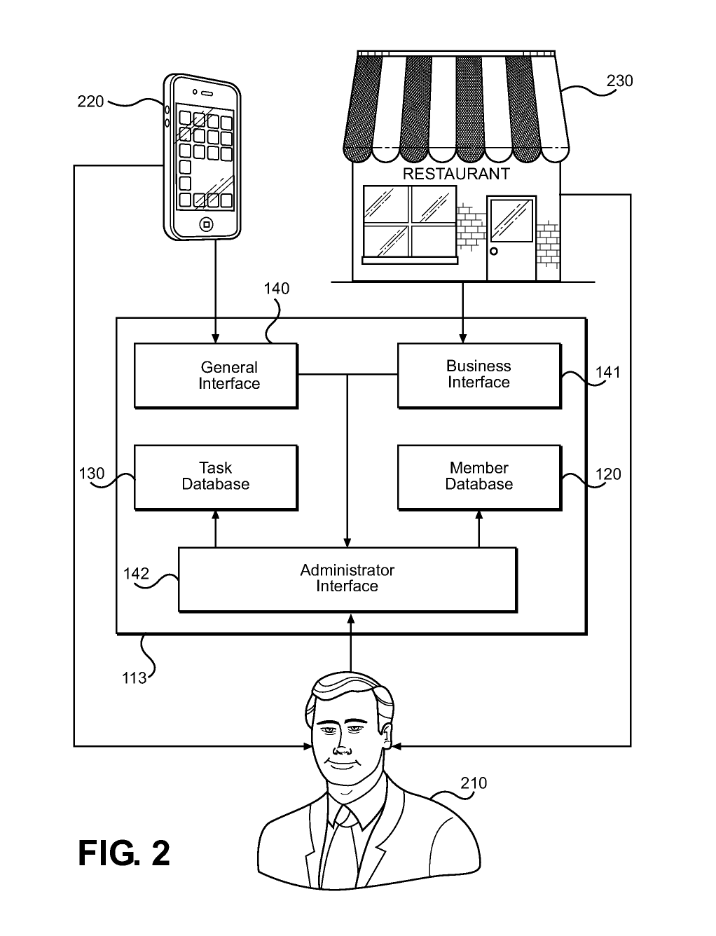

Referring now to FIG. 2, there is shown a diagram of a business user 230 or personal user 220 submitting an activity to the system. New tasks are added to the task fulfillment system either by an administrator 210 who discovers the activity and desires its addition, or by the preferred method of business user or personal user submission. The business user may be any type of commercial establishment. Restaurants, contractors, golf courses, retail shops, indoor rock climbing walls, and art class instructors are a small sampling of possible business users. The business may choose to submit activities such as “dinner for two”, “watercolor painting class”, “ten rounds of mini-golf”, “bathroom remodeling” or any other combination of offered services and products. Some activities will involve a number of steps or sub-activities, while others may be completed in a single outing. Variety in the complexity and length of activities available in the system provides personal users with a great deal of choice in selecting what tasks they would like to attempt.

Similarly, personal users may submit activity suggestions to the system. When a user encounters an activity that he or she believes would make a good activity for others to participate in, the user can submit the activity to the system. Dinner at a new restaurant, installing a pool, losing twenty pounds, and making a scrapbook are examples of activities that personal users might encourage others to engage in. Optionally, the system may present users with a means to share the proposed task with friends through the system to solicit support for the proposed addition before submitting it to an administrator for approval.

To submit a proposed activity to the system, a business user 230 or personal user 220 can either submit information about the activity through a website interface 141,142 or call a customer service representative/administrator 210 directly. In the preferred method, the business or personal user logs in to the website's business or general interface as appropriate, and enters information about the activity. Fields will be presented to the user, prompting him or her for the type of activity, description, length of activity, level of fitness required, cost, hours of availability, and any special requirements for participation. Other fields may be added according to the type of activity selected. Conversely, fields may also be dropped if the user is a repeat submitter and information about the activity is already stored within the system. Once the information is provided and the activity is submitted, a notification is sent to the administrator interface 142 that there is a pending activity request. An administrative user 210 accessing the administrator interface can review the activity request and approve or deny it based on the information provided. Likewise, a business user can call customer service and the customer service representative, an administrative user, may input activity information manually into the administrator interface and approve the activity upon completion. This provides users with multiple methods of submitting an activity and permits interaction with an administrative user if the submitter has questions about the appropriateness of their task.

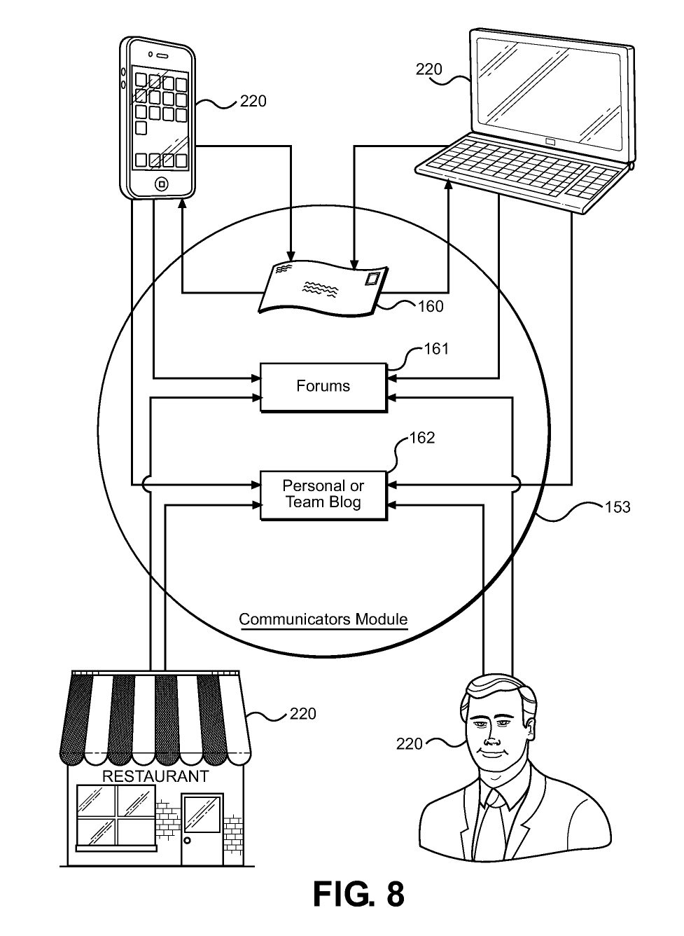

After an administrative user confirms approval of an activity the system creates a task item in the task database 130 for storage on the storage means 113. An initial score will be assigned to the task by the scoring module (see FIG. 8) based on factors such as the type of task, number of steps needed for completion and difficulty of the steps. This score will be stored in a database field. Other fields such as number of users participating. And optionally the user names of participating users will also be stored in association with the task. If the provided information indicates that the task is available immediately then the task will be “published”, meaning that it is active. Task database queries that relate to the specific task item will return a result for that task item and it's associated activity information. If the activity is not immediately available or delayed publication was requested, then the task item will be stored in the task database but will not be returned by database queries until the specified publication date. Thus the task database contains information on all system tasks, active and inactive, published and unpublished.

Additionally, the system rewards the creativity of personal users who submit tasks, by incrementing their earned point score. Personal users who submit tasks that are approved by an administrator are given points in exchange for their assistance with helping the system grow. This is an especially important feature because it facilitates community interaction and point accrual by users who might not be able to participate in the full range of activities offered by the system. Persons with disabilities, minors, or the elderly who may be unable to participate in some activities can earn points by suggesting activities of their own. Such users are encouraged to submit new tasks that would appeal to people of all ages and skill levels.

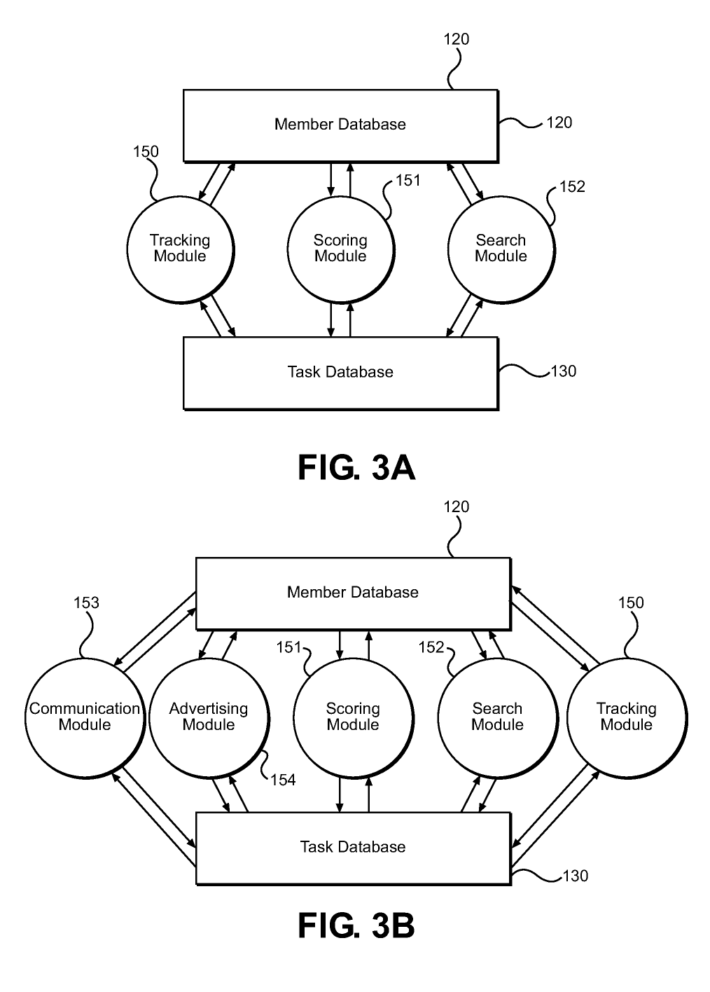

Turning now to FIG. 3A, a second database, the member database 120 is shown and contains information about all system users including personal, business, and administrative users. The scope of the information associated with each type of user will vary according to the implementation of the system. Data regarding a personal user's name, contract information, interests, current task progress and task history; or a business user's contact information, sponsored tasks, and advertising information may be gathered and stored in member database. Both the task database 130 and the member database may be implemented on the same server. Any type of webhosting database may be used to implement the task and member databases. Examples of webhosting databases include but are not limited to MySQL, Microsoft SQL, PostgreSQL, Oracle, DB2, and the like. Methods of implementing web-hosting databases are well known in the art and it will be obvious to one of ordinary skill as to what type of databases best suit the system implementation.

The two databases are accessed by a variety of website modules that provide information and services to users. Modules such as a task-tracking module 150, scoring module 151, and search module 152 are examples of routines that can access and modify database entries as needed. The modules assist users with finding new tasks to engage in, tracking the tasks they are participating in or have completed, and competing with other users for points and rewards. These modules facilitate the intended functionality of the system and are integrated into the various user interfaces of the website. Scripts and routines that provide website users with database interaction capabilities are well known in the art of website design and architecture. As such, the modules may be implemented in a variety of ways using whatever language the system architect deems appropriate.

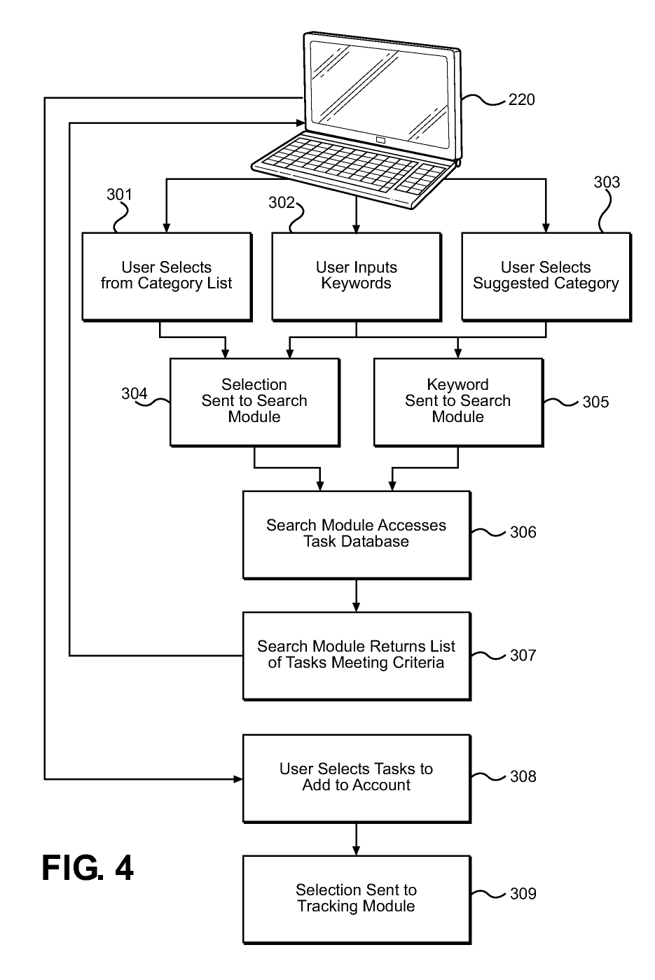

In FIG. 4 a flowchart is used to illustrate an exemplary use of the search module. The system provides a personal user 220 with several ways to search for new tasks. In the first option the system provides a user with a list of categories 301, from which one or more selections can be made. This list may be in the form of checkboxes, radio buttons, a drop down menu, or any other selectable list format. Examples of task categories are local new additions, adventure & risk taking, dining & entertainment, family & community, health & fitness, self-improvement, sports & recreation, travel and sightseeing, team activities, and featured local activities. The selectable list option is a fast way for users to see a broad range of available tasks. A second means is a system provided text box for a user to input keywords 302 related to a desired task. Users may input keywords such as a name of an activity, a category of activity, or a sponsoring business into the text box. This search method provides users with a greater degree of control over the specificity of search results. Optionally a third means may be provided where the system suggests tasks or task categories 303 to users based on their prior task history. A user's prior task history would be evaluated based on recent completions and most used categories, in order to offer suggestions. The suggestion may appear as a link to the task or may appear as automatically selected categories within a list, or auto-filled text within a search box. Users may choose to delete the text, or uncheck he boxes if they are not interested in the suggested search. After making any selections or entering any keywords, the user then clicks on a submission button to begin the search process.

Once a search is submitted, selected categories or entered keywords are compiled into a set of database queries by the search module 304, 305. The queries are run on the task database 306. Fields within the database are checked for matches of category and search terms. All matches are returned to the user as search results 307 and are preferably placed within a visually organized, sortable list. The exact configuration and scope of the returned information may vary according to the implementation of the invention. In an exemplary embodiment the name of the task, sponsoring business or personal user, associated score, and category will be presented to the user. This information may be presented in the form of hyperlinks, so that interested users can select the link to see the specific task, all tasks in a category, all tasks of the same score value, and all tasks sponsored by a particular business or personal user. A user can browse available tasks based on the criteria he or she deems most important. After the user chooses the task(s) to undertake, the user interacts with a selection means such as a submit button, a selection box, or the like. The selection is sent to the tracking module 309 so that the task may be linked to the user's member account.

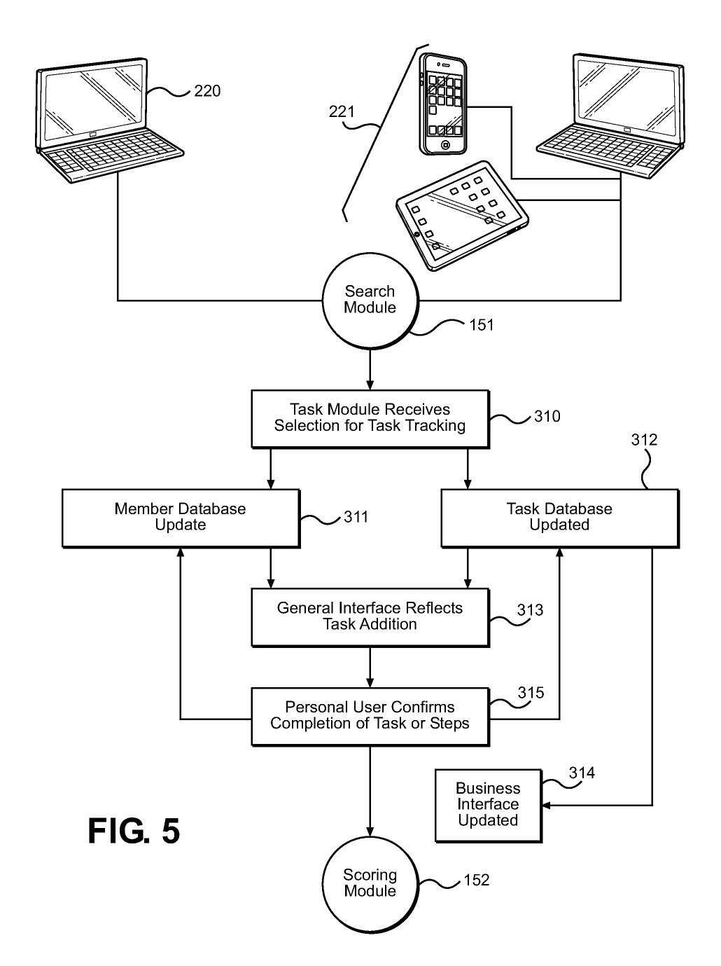

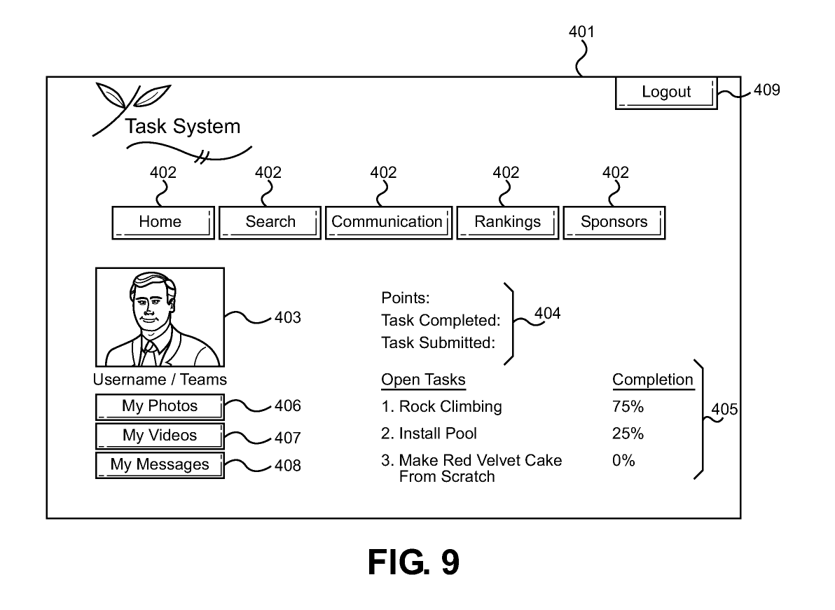

In FIG. 5, task tracking by the system is illustrated. Personal users 220 or a team of personal users 221 find a task via the search module 151 and select the task for addition to their member account(s) (see FIG. 4). Notice is sent to the task-tracking module, which receives the selection 310 and begins the tracking process by pulling information about the task steps from the task database. The member database entries for the personal user(s) are updated 311 by modifying the current tasks information to include the selected task and it's associated steps. Updates to the task entry in the task database are made 312, such as incrementing a count of how many users are participating in a task, and optional the usernames of participating users. After database updates are performed, the general interface of the requesting personal user(s) will refresh to show the user's current task log (see 313 FIG. 9). Steps required for completion of a task may be shown to the user in the log, or may be available though a drop down menu or the like, to conserve visual space.

As the user or team of users completes parts of a task, they will indicate what steps are complete in their task log 315. For example, a family team of users may elect to start an “install a pool” task comprising the steps of “pool style selected”, “dirt removed”, “concrete poured”, and “filled with water.” After the family selects the type of pool, one user can check the step off as complete in their member interface. Because completion progress changes prompt the tracking module to update the member database and task database to indicate task progress, the task completion progress will be updated for all members of the team. When the other members of the team log in to their user accounts they can view the updated progress information in their current task logs. The system architect may choose to have progress updates include modifications to the information of the business user 314 sponsoring a task. A counter for the number of users participating in a task may be incremented and an average completion percentage may be calculated. This information would be displayed to the sponsoring business user when he or she logs in to their account. In this manner, the system provides businesses with a means for tracking what activities are popular and how far, on average, users go towards completing the task. Completed tasks, or task steps are sent to the scorings module 152 for score calculation and assignment.

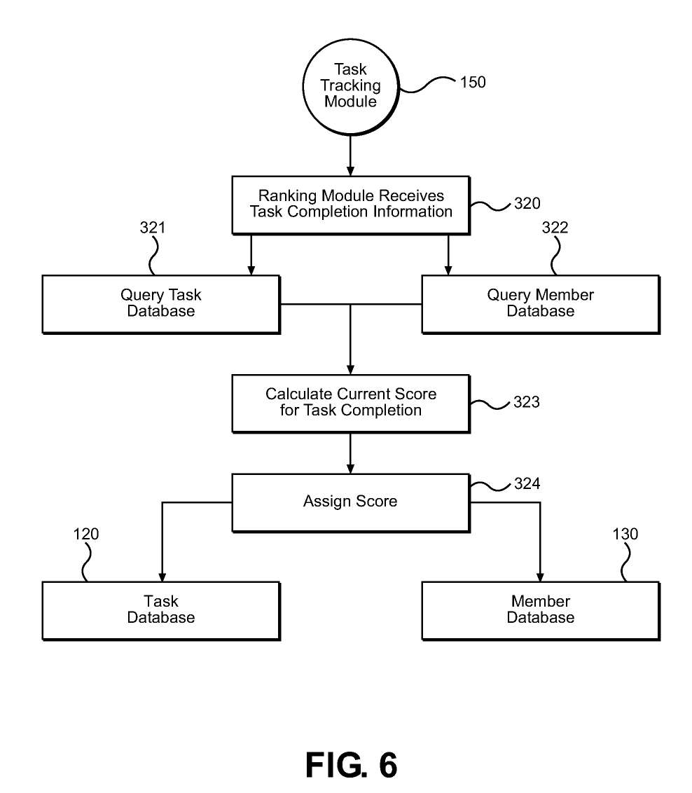

The function of the scoring module is displayed in FIG. 6. After a user marks a task as fully complete the task-tracking module 150 sends identifying information for the personal user or team, and completed task to the scoring module. Identifying information may be in the form of usernames and task name, system assigned user and task id numbers, or any other means of identifying specific users and tasks. The scoring module receives the user and task information 320 and sends a query to both the task and member databases. The information returned by the task database query 321 and the member database query 322 is used to calculate a current score for the completed task 323. As such, the information requested from each database will depend upon the formula used for score calculation. In an exemplary embodiment score calculation will depend upon a difficulty level assigned to the task by an administrator during task creation, the number of users who have undertaken the task, and the number of users who have completed the task. The larger the number of steps a task requires, the greater its point value. This number will likely be uniform across all tasks of a particular step number and category; but may be dynamic depending upon the average number of steps needed for tasks within the category. By contrast, the difficulty factor will be decreased proportionally as the number of users who have completed the task increases. Thus as more users complete a task it's point value may drop. In this preferred embodiment, users and teams are only assigned points when a task is fully completed. In alternative embodiments points may be assigned based on completion of the steps of a task. And how many users have completed each step of that task, in addition to the aforementioned variables, will be factors used to calculate the point value assigned for progressing through task steps. This flexibility in score calculation provides the system implementers with a variety of options when determining scoring. The precise formula used to determine point values will vary according to the implementation of the system, but it is preferred that the number of users who have completed the task is a determining factor in the calculation. Making point values elastic will encourage competition amongst users as they work towards goal completion and participate in new activities.

The calculated task score is then assigned to the user(s) 324. It will be added to the user's score in the member database 120. Awards may also be assigned to the user for particular accomplishments during task completion. First user to complete, fastest completion time, and largest team assembled are examples of task completion awards. The newly calculated total score and any awards given w will be presented on the general interface of the personal user or interfaces of team members. The task database will also be updated to reflect the current point value associated with the task, for use in future score calculations and task searches.

Personal users who submit new tasks to the system may also be assigned points for their submission. Once the submitted task is approved by an administrator and added to the system, the user's earned point score will be increased in the member database. A field in the member database will be used to store a count of how many tasks the user has successfully added to the system. The score associated with submission of a task may be the same for all submissions or may vary according to the difficulty of the task, as assessed by the administrator user. Users thus have an incentive to help submit tasks to the system and increase the numerosity of available tasks.

In one embodiment a user's earned point score is static. Though score values are recalculated upon task completion, a user's earned point score does not vary aside from the addition of newly earned points. This embodiment reduces the load on the system by negating the need for frequent, recalculations of the earned point score of large numbers of users. It also rewards users for being among the first to complete a task by assigning an initial point value that will not diminish as future users complete the task. In this manner, the embodiment encourages users and teams to seek out new tasks to complete rather than simply sticking with tasks that numerous other people have completed.

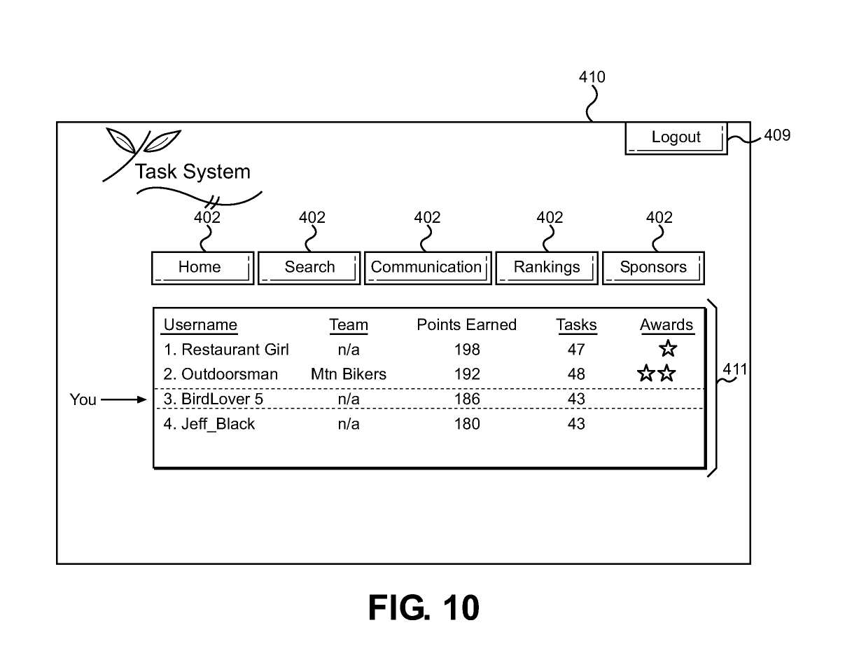

In a second embodiment the earned point scores of all users are variable. In this embodiment a permanent earned point score will not be stored in the member database along with the user's personal information. Instead, the task history information will be used to generate a user's earned point value dynamically. When a user accesses the website's rankings page (see FIG. 10) a filterable chart will be displayed showing the rank of system users according to earned point values. The earned point values of users is calculated during this process based on current task point values. As new tasks are added and existing tasks are completed, point values will be increased or decreased by the scoring module. User earned point values will be regularly fluctuating as members complete goals. This version of the system forces users to stay active and engaged in task completion if they want to maintain high point values. It will be appreciated by highly competitive and active users, but will result in a significant increase in calculation load on the system and database access calls.

Returning now to FIG. 3B, the interaction between the member database 120 and the task database 130 via a plurality of website modules is shown. The task-tracking module 150, search modules 152, and scoring module 151 are included as well as the additional advertising module 154 and communications module 153. These modules provide optional features that may be implemented by the system architect and are contemplated as part of an alternative embodiment of the system. The advertising module provides administrators with a means for incorporating business advertising into the system and the communications module facilitates intra-system communication between personal users. These functions extend the system's functionality and will further connect personal users to each other and to businesses, but these measures are not necessary to the primary implementation of the system.

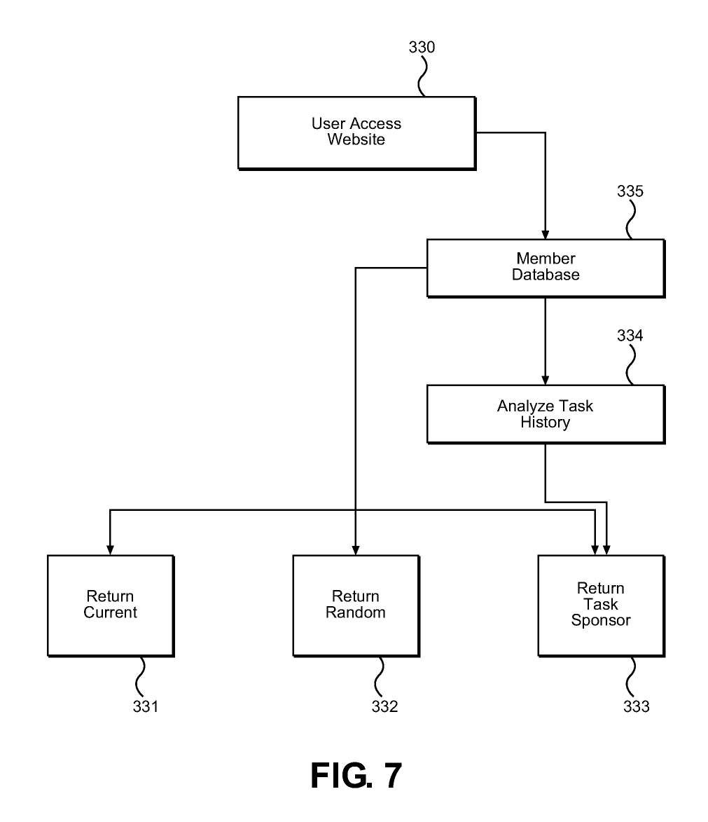

The system may also include means for displaying advertising of task sponsors, as shown in FIG. 7. This can occur in several ways including the static display of advertiser links on specific locations within a webpage, dynamic display of advertising based on current user selection, or dynamic display of advertising targeted towards user history. When a personal user accesses the system website 330 advertising links may be presented. The featured advertisement may be predetermined by a website administrator so that the current choice for advertising is displayed to all users. An indicator within the member database may be used to mark the current advertising selection. The current choice is assigned and updated by the website administrator on a regular basis. Upon access of the website by a personal user, the member database 135 is accessed and returns information of the business user selected as the current advertising choice 331. Alternatively, the website administrator may set the advertising selection to be random, so that the member database returns the advertising information of a random business user 332 for display on the website.

As he or she navigates through the website to their general interface and member account advertising may be presented based on the user's selections and preferences. The advertising module notes the user's current browsing location within the website and accesses the member database for advertising information about business users sponsoring the currently viewed content 333. For instance, a user browsing through tasks in the adventure & risk-taking category may be presented with advertising associated with tasks displayed on the task list. Rock climbing walls, bike trip organizers, and cruise companies the like are examples of advertisers that might be presented in association with adventure tasks. Advertisements of this nature should be directly related to tasks appearing on the user's currently viewed page

Another advertising method utilizes a personal user's task completion history to offer targeted advertising to the user throughout his or her website browsing experience. Once a personal user logs in to his or her member account, the website queries the member database for the user's task history. The user's task history is then analyzed 334 for patterns regarding a user's task interests. Factors such as the most recently used category and most used category are considered in determined what advertising should be displayed. Advertising displayed may be determined according to a single factor, or displayed proportionally according to a weight assigned to different factors. By way of illustration, a user who's completed goals fall within the categories of arts & crafts, and health & lifestyle may be shown advertising on the webpage that focuses on both of these categories. Targeted advertising provides a means for suggesting goods and services to users based on their interests, increasing the likelihood that the user will click on the advertising or explore the offer. Methods of advertising on a webpage are known in the art of website development and the methods of advertising should not be strictly limited to those methods described herein.

The communications module, shown in FIG. 8, comprises several different communications means for use by system participants. Intra-system mail 160, forums 161, and blogs 162 are contemplated, but other social interaction methods may also be used. These functions may be offered only through specific portions of the website or may be selectable options on any given portion of the website. Thus, there can be a link on all pages to “forums” so that users can navigate to a specific page for the forums. Alternatively, links for forums, blog, and messaging may appear next to associated task selections in order to provide users with a greater deal of information about the particular task. There are a broad variety of communication function implementations available in the art of website design and development. The present invention is not limited to one specific implementation but may be expanded and modified to fit the needs of the system.

Intra-system mailing means such as email or instant messaging connects personal users 220 to each other so that they can coordinate task completion or discuss activities. Communications of this type should be directly between one or more personal users. This function helps users meet new people and facilitates the organization of teams by allowing users to talk to others who share their interests. User can find new people to talk to by browsing the web forums, reading blogs, or viewing task related comments posted by other website members. In this way, the system promotes not only the discovery of new hobbies and interests, but also the building of new relationships.

Website forums 161 provide a means for personal users 220, business users 230, and administrative users 210 to interact. The system administrators can use a discussion board or forum to post updates, information about website changes and answer any user questions. Business users can make posts regarding upcoming task submissions, suggestions for completing tasks, and answer questions about the business. Personal users may post topics about various tasks, categories or tasks, or related subjects. Forums give administrators and business users a way to interact with eh personal user community. Announcements can be made and questions answered to a larger audience than through individual email. The forums also provide individual users with an online place to encounter and talk to other people who share their hobbies and interests. Website forums thus provide an excellent means for encouraging team creation.

Another communication means facilitated by the module may be user blogs 162. These are online journals created and maintained by a user. The system may have a blog written by administrative users 210 that addresses system updates or maintenance schedules. Business users 230 may have blogs that announce upcoming events or offers from the business. Personal users 220 can keep a record of their experiences while completing tasks and working on teams. Any of these journals are available for the community to read. Each user's comments and thoughts on their experiences may be useful to others in the community when deciding what tasks to perform and what activities to participate in. For example, For example, a user reading the new attractions category forum might find another user who shares his interests, select that person's profile and browse the person's blog where the user can read about tasks the person performed.

Turning now to the user interface experience offered by the website, an exemplary embodiment of the general interface is shown in FIGS. 9 & 10. A set of navigation buttons 402 enables easy navigation around the website by a user. Examples of navigation buttons include a home button to direct users to the website main page, a search button to direct a user to the task searching function, a communications button directed to website forums, a rankings button directed towards the ranking boards, and a sponsors button to take users to sponsored links and advertising offers. Once the user is logged in, his or her member settings will be displayed in a co-located area. A selected member photo 403, member name, names of any team associations, and links to the user's photo gallery 406, videos 407 and messages 408. The user's media gallery contains uploaded photos and videos of the user performing tasks. Users can submit snapshots of themselves performing various steps of a task and then link these photos to the task for other users to view. These can be a useful source of information to users contemplating trying a new task. For instance a user contemplating trying out a local pool can view pictures of the pool too see if it is large enough for lap swimming. The messages feature is used to direct users to their intra-system mail, messages from system administrators, or to the user's blog.

A user's current task log 405 is displayed in FIG. 9. The log may be implemented in an ordered chart or list fashion. It should display the tasks a user has selected for tracking and an indication of how close the user is to completion. Users can also view the individual steps completed for each task listed. The steps associated with the task may be displayed below/next to a task, on moving the mouse pointer over of the task name, or a dropdown box can appear upon clicking the name. Other visual means of displaying task steps are also contemplated and those listed herein are provided for exemplary purposes. Completed tasks may also be shown on the chart or may be available via a separate chart. A set of completion statistics 404 is displayed near the task-tracking list. Counts of the user's earned points, tasks submitted, and tasks completed are provided for the user's reference.

If a user is interested in seeing more information about his or her score they can reference the rankings page, shown in FIG. 10. Users are ranked according to the scores provided by the scoring module and placed within an organized chart. 411. By default the list is organized according to earned point score in descending order, but it may be sorted so that users can view how team members are performing or who has completed the most tasks, and the like. The rankings board shows user names, associated team names, points earned, tasks completed, and any awards earned. Multiple rankings boards are available to system users, they can select national boards, local boards, team boards, or boards of their stored friends. These boards are an important part of the invention as they encourage friendly competition amongst users in a locality, on a team, and even across the nation.

In an alternative embodiment, the points earned by users are redeemable for gift certificates with advertisers and discounts on services associated with tasks. This will cause constant fluctuation in the rankings boards as users earn points by completing tasks then use those points to aid in the completion of new tasks. In a similar alternative embodiment, the earned point score may be separate from redeemable point score, so that a user can spend task completion points without dropping his or her score with respect to rankings. Teams may spend the points together or individually, to further facilitate cooperative progression towards group goals. To do this, teams should have a separate redeemable point bank based on team-completed tasks, as opposed to tasks completed by the users as individuals.

Thus the system provides personal users with a means of trying new activities and tracking their progress towards those activities. Users can compete against each other individually or in teams to see who participates in more activities. As users participate, they will make new friends and discover new real world experiences away from the online world. In this way, the system provides users with a means for getting outside and enjoying the world away from the Internet. The system also provides businesses with a means for offering goods and services to local community members and gaining customer exposure through online interaction. Thus the system promotes not just personal growth but also the growth of local businesses and community organizations.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A task management and completion system comprising:
a server having a central processing unit, a main memory, a storage media, and a network connection means;
a network;
a database stored on said storage media, wherein said database contains data pertaining to a plurality of system users and a plurality of tasks;
a website hosted on said server, wherein said website has a plurality of user interfaces, a task-tracking module, a search module, and a scoring module;
said system users comprising personal users or teams of personal users, who undertake system tasks and earn points for completion of said tasks;
said system users further comprising administrative users, who manage the system;
and wherein new tasks are submitted to the system by any of said system users.

2) The system of claim 1, wherein said database is divided into a task database that stores task information, and a member database that stores user information.

3) The system of claim 1, wherein said system users further comprises:
business users, who are commercial entities sponsoring system tasks.

4) The system of claim 1, wherein said teams of personal users are groups of individual personal users that are linked within said database such that task completion information and points are attributed to all personal users in the team.

5) The system of claim 1, wherein the system provides a different user interface to each type of user.

6) The system of claim 1, wherein tasks submitted to the system must be approved by an administrative user prior to addition to the database.

7) The system of claim 1, wherein a personal user or team of personal users earns points for submitting tasks that are added to the system, and said points are added an to an earned point value of said user or users.

8) The system of claim 1, wherein said search module provides a means for searching for available system tasks.

9) The system of claim 8, wherein keywords, category types, or names of task sponsors are used as search queries.

10) The system of claim 8, wherein the search module suggests search criteria to a personal user or team of personal users based on their task completion history.

11) The system of claim 1, wherein said task-tracking module keeps track of a personal user's or team of personal users' progress towards completion of a task, and stores task completion information within said database.

12) The system of claim 11, wherein a personal user or team of personal users reports completion of task steps to the system and the task-tracking module updates task progress information within said database.

13) The system of claim 1, wherein said scoring module calculates a score for a particular tasks and assigns said score to a personal user or team of personal user's earned point value.

14) The system of claim 13, wherein said score calculation is based on the number of users who have completed the particular task.

15) The system of claim 13, wherein said score calculation is performed after said task-tracking module designates a task as fully completed.

16) The system of claim 13, wherein said score calculation is performed after each step of a task is designated by said task-tracking module as completed.

17) The system of claim 13, wherein personal users and teams of users are ranked according to their earned point values, and wherein said ranking of users is published on said website,

18) The system of claim 1, further comprising:
a communications module that facilitates intra-system communication between different types of users.

19) The system of claim 1, further comprising:
an advertising module that selects advertising and displays said advertising on said website.

20) The system of claim 19, wherein said advertising selection is predetermined by an administrative user.

21) The system of claim 19, wherein said advertising selection is based upon a personal user's current browsing habits.

22) The system of claim 19, wherein said advertising selection is based upon a personal user's or team of personal users' task completion history.
